(19) United States
(12) Patent Application Publication
(10) Pub. No.: US 2004/0023712 A1
(43) Pub. Date: Feb. 5, 2004

(54) Method for casino table game play

(76) Inventor: Terrance William Oliver, Reno, NV (US)

Correspondence Address: DORR CARSON SLOAN & BIRNEY, PC, 3010 EAST 6TH AVENUE, DENVER, CO, 80206

(21) Appl. No.: 10/213,310

(22) Filed: Aug. 5, 2002

(51) Int. Cl. A63F 13/00

(52) U.S. Cl. 463/18

(57) ABSTRACT

A method playing a live casino game by including a jackpot as a required feature in which each player makes at least one mandatory jackpot wager to play the game and a player makes a separate wager to win a separate, additional payoff amount. Each player makes at least one mandatory jackpot wager as an ante wager before making a wager and participating in the underlying live casino game. The ante wager is separated into a casino portion and a jackpot-funding portion. The pay tables and rules of the game are set to return wagers for optimal play over time as payoffs to players on the basis of a zero or near zero negative house advantage. The pay tables for the jackpot feature and the live casino game are displayed to the player. The underlying game is played according to the rule of play for the game. The player is awarded a payoff amount by achieving one of the plurality of winning arrangements according to the pay table and the rules of the underlying live casino game, and according to the pay schedule of the jackpot fund. Typical live casino games include five-card stud poker, baccarat, pai gow poker, blackjack and roulette.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to and, in particular, to improvements in the methods for playing a live casino table game wherein the player is required to make an ante bet to fund a progressive jackpot before play. It is required for each player to participate in the progressive jackpot component of the game because the underlying card game has no input to the house share, advantage or handle. The live casino table game is played according to rules of play and is paid in accord with a pay table for listed winning hands.

2. Description of Related Art Including Information Disclosed Under 37 CFR 1.97 AND 1.98

The present invention generally relates to casino or card room gaming involving a jackpot. More particularly, it relates to a progressive jackpot that is available to be played by participants in casino or card room table games. Recognizing that a jackpot can be a progressively built amount or preset amount and that the live table card games herein are more exciting if a progressive amount is included. It has become common practice in gaming establishments to provide a progressive jackpot component in connection with electronic or mechanical gaming devices, such as slot machines, video poker machines or keno machines. Thus a plurality or “bank” of machines are electronically interconnected to a common progressive jackpot meter. As gaming tokens are fed into each machine, the amount shown on the jackpot meter progresses incrementally until some lucky player lines up the winning combination, such as three or four 7's on the same row of a slot machine. In video poker, a Royal Flush normally wins the jackpot, although in some variations, a player must achieve a Royal Flush in an exact order, such as A-K-Q-J-10 from left to right, or in a particular suit, such as Spades. In video keno, a player typically must match 15 out of 15 numbers to win the progressive jackpot. In the present invention a progressive jackpot component to typical casino or card room table games such as poker or Twenty-One is provided.

Players in the progressive jackpot component win all or part of the amount shown on the progressive jackpot meter if the player achieves a particular predetermined playing hand. When the progressive jackpot component is added to typical table games such as poker or Twenty-One, the players enjoy these games more and the amount of play will increase. A progressive jackpot meter electronically interconnected to one or more gaming tables allows each player at his playing location to participate in the progressive jackpot component by wagering a gaming token and automatically increment the progressive jackpot meter. Ordinarily the players of the live table game give back to the casino a part of the underlying game and the progressive jackpot.

U.S. Pat. No. 6,234,895 has each gaming token placed-in a coin acceptor results in the amount shown on the progressive jackpot meter being increased by a predetermined amount. If, for example, each gaming token has a value of one dollar, then the amount shown on the progressive jackpot meter would be increased by any amount up to one dollar for each gaming token placed into a coin acceptor. The progressive jackpot would preferably be increased between 93% to 97% of the amount of each gaming token being wagered, the balance representing the house's share of the amount wagered for providing the progressive jackpot component of the game. The disclosure of the 6,234,895 patent is incorporated by reference and made a part hereof of all purposes of disclosure.

Notably absent is any suggestion or disclosure of zero house advantage on the underlying live table card game. At best there is nothing at all about the house share, advantage, table take or drop. This is apparently so since it is assumed that the house or casino keeps what the players lose on the underlying live table card game. No where is there disclosed the idea that the pay table or the rules of the game are or can be adjusted to give back to the players of the underlying game over time all that they lose. It is of enormous value to the casino that skilled players appreciate they have a much better chance to win in the underlying live table game because of their ability and experience wherein the pay table or rules of the game give it all back to the players over time. The reason for the foregoing conclusion is that the savvy player will choose these live table card games over all others and play more frequently. How exactly the pay table is arranged, rules of the game modified and how short the cycle is to even up the score is typical within the ability of the skilled artisan. The several methods disclosed herein are by way of example and are limiting. Too, the apparatus in ‘895 is useful for playing requiring merely a lockout to insure that all the players ante prior to play and that the pay table returns over time all other wagers in the underlying card game. This does not mean all the players get their bets back but that those winners in the underlying card game take over time all collected bets for optimal play of the underlying game that are not ante. Foolish or inept play is not protected from the house. The ante bets pay the progressive jackpot and the casino or house share, hold, drop, handle or advantage.

There have been several modifications to the rules of table games to eliminate the need for a separate commission by the house. The purposes of these changes have been designed to allow the house to adjust the percentage of the hold amount by modification of the rules instead of modifying the percentage of the house fee. Some examples of these rule modifications are described below.

U.S. Pat. No. 5,868,392 describes a method playing a version of five-card poker where the usual “rake” is eliminated and replaced with a variety of additional wages for which specific pay-offs are identified. In a conventional card room poker game played at a commercial gaming facility, the casino or “house” provides a dealer, the playing cards, the table, the chairs, and, most likely, the gaming chips. Although the house provides the dealer, the dealer is not dealt any cards, nor does the dealer place any wagers. Instead, the dealer shuffles and deals the cards, monitors the betting activity of the players, and controls the overall flow and pace of the game. As compensation, the house typically collects a nominal percentage of each player's bet (the “rake”), or a percentage of the total pot (usually capped). Alternatively, the house may charge each player a set fee per hand or a fee for playing a specified length of time.

U.S. Pat. No. 5,362,064 describes a modified method of playing Baccarat in which the conventional 5% commission charged by the gaming establishment on winning bank hand wagers is eliminated. Baccarat is normally played with a multiple number of decks of standard playing cards that are shuffled together and placed in a shoe from which the cards are drawn during the play of the game. The casino advantage in Baccarat lies primarily in the rules of how the banker sets his hand. It is more likely that the banker will win so the casino puts a 5% commission on all bet on the banker by the players. Pre-selected combinations of bank and player hands that would have been winning bank hands under the conventional manner of play of Baccarat are treated as “push” or “bar” hands in '064. Thus the casino can set the house advantage by adjusting the combination of hands that will be “push” or “bar” hands.

U.S. Pat. No. 6,007,424 describes a method to modify the conventional game of Pai Gow Poker than provides for greater payoffs if the player has one of a plurality of payoff qualifying holdings and eliminates the need of a separate commission to the casino on winning hands. As the game is relatively even with respect to odds of the dealer or the player winning the hand, casinos providing Pai Gow Poker take a commission on winning hands of normally five percent.

### BRIEF SUMMARY OF THE INVENTION

The solution may include funding of the progressive component with a share to pay the casino expense and profit for operating the table game. The players have a slightly smaller potential amount to win from the progressive jackpot for a typically greater share of the win for the underlying live card game. It is thus more advantageous for the players to play the underlying game and have opportunities to win more while giving up a relatively small amount of the potential reward to the progressive jackpot. Put another way each player has a slight chance at the big progressive jackpot and in exchange for giving the house a relatively minor share up front of the progressive jackpot allows the player to realize more return in the underlying table card game. This is so because each player in the underlying live table card game has the opportunity to share in a pay table that does not give anything back to the house or casino. Thereby the pay table and/or rules of the game are more generous to the players. Sophisticated players will appreciate quickly the benefit of achieving greater potential pays in the underlying game on a much more frequent basis. The potential loss of a part to fund the progressive jackpot is practically invisible or undeterminable to any table player because of the number of players and underlying live table card games funding the progressive jackpot. Clearly, there will be more players of the better paying underlying live table card games.

Also, the incrementing progressive meter for all the play increases at a rate greater than a typical progressive live table game wherein the house took a part of the underlying game and a part of the progressive jackpot.

### BRIEF DESCRIPTION OF THE DRAWINGS

FIG. 1 is a block diagram showing one method of play with a game of Five Card Stud Poker.

FIG. 2 is a block diagram showing one method of play with a game of Baccarat.

FIG. 3 is a block diagram showing another method of play with a game of Twenty-One.

FIG. 4 is a block diagram showing a still further method of play with a game of Pai Gow Poker.

FIG. 5 is a block diagram showing yet a different method of play with a game of Roulette.

### DETAILED DESCRIPTION OF THE INVENTION

The progressive jackpot may include “prize pool” in addition to a progressive and special enhanced pays for specific hands. Not only traditional casino games such as poker blackjack but also any card game pay table or rules of the game could be altered easily such as the game of War, Red Dog (in between, Acey-Duecy). Too, Baccarat might be a good example as well. Roulette although a table game without cards or any other progressive casino game would work and have the same listed benefits and advantages enumerated. While not specifically, disclosed, skilled artisans would appreciate that jackpot video poker machines could likewise have an altered pay table to not fund the house and a part of the jackpot would merely support that game. The term, “Jackpot” is considered throughout this disclosure a broad designation of any type of side game for which there is a separate pot and includes those that are progressive or are not. Examples that follow are for table games.

For Poker, Blackjack and Baccarat, the simplest way to have a zero percentage house edge is to make the player/dealer rules completely symmetric. This is more difficult with Blackjack because of the potential for busting. Symmetry can be found only in a Black jack double bust or a push that accomplishes exactly what is desired so there must be equality for the other play results while the added mandatory side bet provides the house advantage, handle, table take or edge. Some examples herein demonstrate symmetric games but the other game need not be symmetric. Indeed, the primary wager (underlying game) could also have a player advantage as the mandatory or side wager covers the house. An important distinction is between the mandatory bet for the funded jackpot and the bet in the underlying game is that the former always has a positive house, advantage and the latter has a zero or negative house advantage for approximately optimal play. Of all the casino games, only a few video poker games have been presented with a negative house advantage and those rely on the players' lack of skill to provide a house advantage. Even where a straight game of chance has paid over one hundred percent that was in connection with slot machines wherein the player had to bet maximum coin in to be eligible over time for such an infrequent return. Also because many players failed to bet maximum coin in those machines, casinos typically made a healthy return. The idea to provide a casino game that over time always gives back all or even greater than all in the underlying game to the players in exchange for a mandatory jackpot bet has not been available. Moreover, jackpot funded casino games with no or negative house advantage even if played optimally with or without strategy and/or skill remain unique and untried. It should be noted that term “optimal” refers to game play that provides the greatest return to the player over a period of time. There are many books and articles written on each of these table game that educate the player on the wagering and playing techniques that will yield the greatest return to the player. Anyone skilled in the art of gaming would appreciate how the optimal game is an advantage to the average player.

### Method for Game Play

The following describes four examples of possible embodiments of the invention. The examples are of modified versions of popular table games wherein the change gives the house a zero or nearly zero advantage and wherein the minimum wager required per round of play is a wager on the jackpot bet outcome and wager(s) on the underlying table play. The examples disclosed are Five Card Stud poker, Baccarat, Twenty-One, Pai Gow poker and Roulette. While invention has been illustrated with respect to these four specific embodiments, these embodiments should be considered as illustrative rather than limiting. Also, these examples describe a jackpot qualification in relation to a player's hand. The jackpot could be a community jackpot in which all the players at a table share in the winnings when a combination of hands between one player and other players occur or between one player and the dealer occur.

In the example below a version of Five Card Stud Poker has the instant invention wherein the dealer's strategy is fixed and new rules of bet resolution are symmetrical. That is the when the player's high hand exceeds the dealer's hand then player wins the bet. In a similar manner when the dealer's hand exceeds the player's hand the house wins the bet. In symmetrical play the “rake” is eliminated and the resolution of the payment of tie hands between the player and the house becomes a push. The game has then theoretically a 0% house advantage with optimal player play. The house advantage resides only in the adjustment of the percentage of the required jackpot wager.

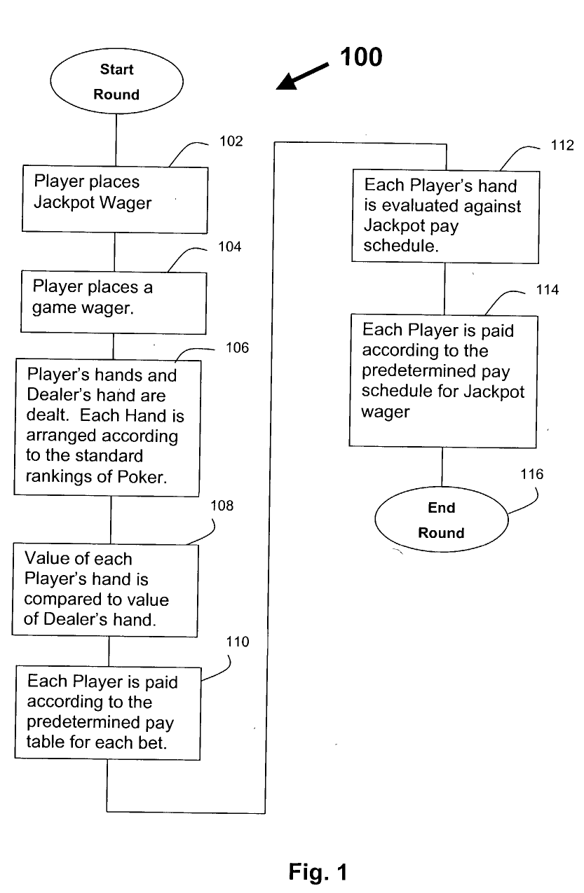

In operation, and referring to FIG. 1, the game begins with each player placing a jackpot wager 102. Each player then makes a game wager 104. The dealer then deals five cards to each player and himself dealer's hand 106. Each player arranges his or her cards into the highest rank hand. The five cards are ranked according to the standard rankings of poker. Once the players have arranged their hands, the dealer exposes his cards and likewise arranges them into a five card high hand. Thereafter the hands are resolved to determine wins, losses and pushes 108.

For a player to win the game wager, the hand must outrank, according to the standard rules of ranking hands of poker, the hand of the dealer 110. If the players' hand does outrank the dealer's, the player wins the wager and he is paid even money by the dealer. If the dealer's hand outranks the players' hand, that outcome is a loss for the player and his wager is collected. In resolving the hands, wherein any player's hand ties dealer's hand, the wager is a push.

Each player's hand is then evaluated for the results of the jackpot wager 112. Each Player is paid according, to the predetermined pay schedule for the jackpot wager 114. This concludes the round and players have the opportunity to play another round of the game 116.

Another example of the instant invention is a method of playing a version of the casino table game of Baccarat. In the instant invention the commission is eliminated but the resolution of the payment of wagers is done in the standard fashion and thus the overall house edge becomes 0% for either Banker or Player bets. The house advantage lies in the adjustment of the percentage of the required jackpot wager to create the house advantage. This is generally equal to the standard five percent commission of the conventional game but can be in any range determined by local regulations and procedures.

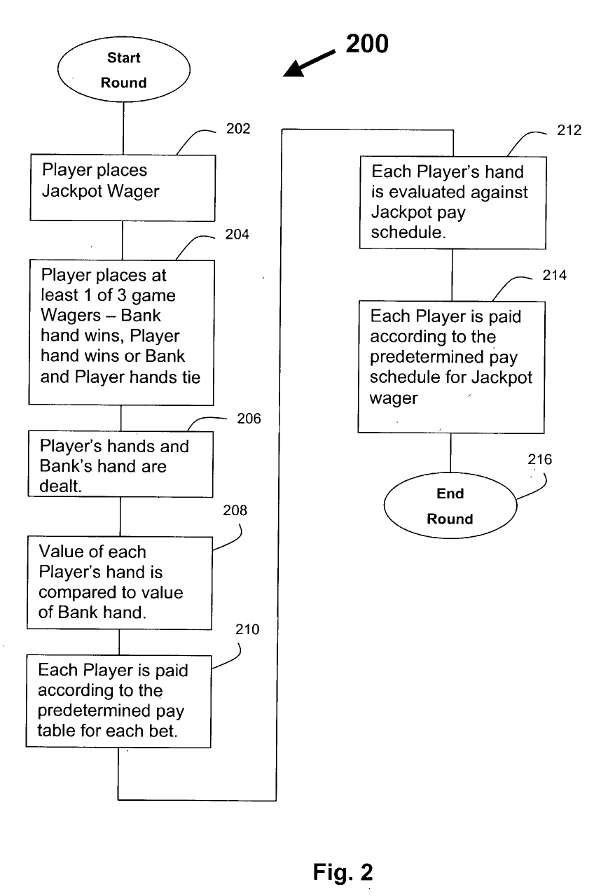

In use and operation, and referring to FIG. 2, the Baccarat game 200 begins with each player placing a jackpot wager 202. Prior to the deal, each player can make one of three more table game wagers: 1) that the Bank hand will win; 2) that the player's hand will win; or 3) that the bank hand and the Player hand will tie 204. After all wagers are made, two cards are dealt from the shoe to the bank position and two cards are dealt from the shoe to the player's position 206. The cards are turned face up and the value of the Bank's hand and each Player's hand is determined 208. Aces count one; Kings, Queens, Jacks and Tens count zero and the other cards count their respective face value. The suits have no meaning in Baccarat.

The highest hand value in Baccarat is nine. All hand values range from a low of zero to a high of nine. If when the cards are added together, the total of the hand exceeds nine, then the hand value is determined by subtracting ten from the total of the hand. For example, a seven and an eight total fifteen, but the hand value is five. Likewise an ace and a nine total ten, but the hand value is zero. A two-card total of eight or nine is called a “natural”; a two card total of zero is called, “Baccarat”. Certain rules require that a third card be dealt. The value of this third card is added to the total of the first two cards and a new hand value is established. Again, if the new hand total exceeds nine, the hand value is determined by subtracting ten from, the total of the hand. Whichever of the Bank or the Player hand is closest to a total of nine is the winner. All winning hand wagers are paid off at predetermined odds, which is usually one to one. Each player is paid according to the relative value of each of player's bets 210. Each player's hand is then evaluated for the results of the jackpot wager 212. Each player is paid according to the predetermined pay schedule for the jackpot wager 214. This concludes the round and players have the opportunity to play another round of the game 216.

In another example of the instant invention, the table game of Blackjack, herein referred to as Twenty One, the house advantage is eliminated by the use of modified rules that provide for symmetry for both the player and dealer and thus the overall house edge becomes zero on either a bet on the dealer or the player. The casino's primary advantage in Blackjack lies on the fact that the player can bust before the dealer. Because there is a wide variety in the different Blackjack rules for hitting, standing, wagering against a dealer Blackjack hand, splitting and doubling down it is difficult to make the house advantage exactly 0%. Thus, in the instant invention the rules are modified to make them symmetrical for both the dealer and player. For one example of symmetry, both the player and dealer must hit until reaching 17 or more. Double downs and splitting of cards are not allowed. Natural 21 pays only 1 to 1. If both the player and dealer bust then the bet is a push. If neither side busts then the hands are compared to resolve the bet. The house advantage lies in the adjustment of the percentage of the required jackpot wager to create the house advantage approximately equal to the conventional Blackjack game.

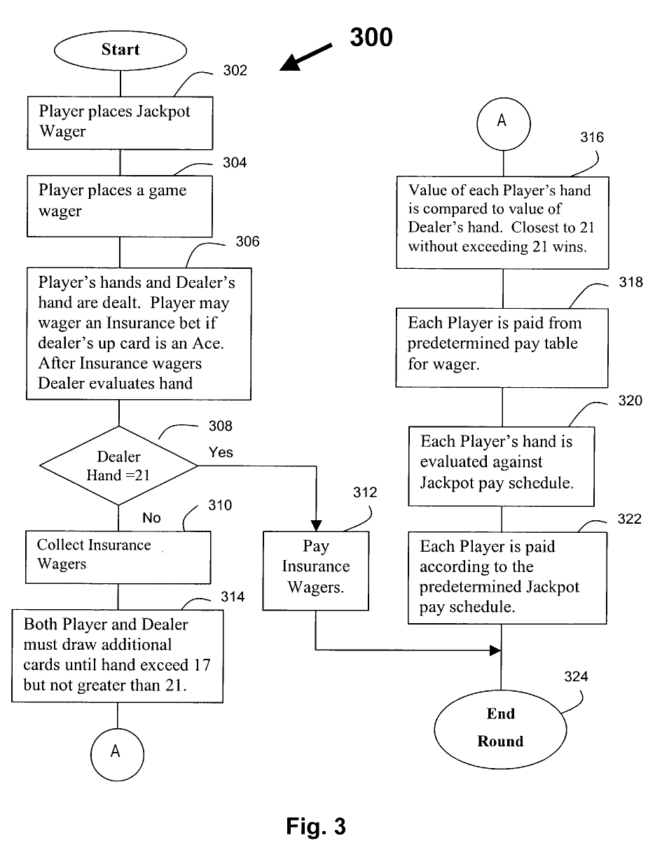

In operation and play, and referring to FIG. 3, the game of chance, Twenty-One at 300, is between a dealer and one or more players using one or more standard decks having fifty-two playing cards. The object is for the player to achieve a card count closer to 21 without going over 21 than the dealer's card count. The method of play of Twenty-One is as follows: A standard deck of fifty-two playing cards is used and each card counts at face value, except Aces that are valued at one or eleven as is most beneficial to the count of the hand. Face cards, i.e. Kings, Queens and Jacks, have a count of ten. The game begins with each Player placing a jackpot wager 302. Each player then makes a game wager 304.

After making wagers, each player initially receives two cards. The dealer also receives two cards. One of the dealer's cards is dealt face down and the other of the dealer's cards is dealt face-up. When the dealer's up card is an Ace, each player can wager one-half of the amount of his original wager as insurance against the dealer having a Blackjack, i.e. a two-card 21 count (an Ace and a 10 count card such as a King, Queen, Jack or Ten) 306. The insurance bets are made after each player receives his first two cards and the dealer reveals his up card and before any additional cards are dealt.

If the dealer has a two-card 21 count 308, the player loses on his original wager but wins two-to-one odds on his second “insurance” bet 312. Also if the dealer has a two-card 21 count, that round of the game is over, players may not draw additional cards and all players lose except those who also have two-card 21 counts who tie or “push” with the dealer 324. If the dealer does not have a two-card 21 count, the player loses on his “insurance” bet and the round of the game continues 310. A player may draw additional cards (take “hits”) in order to try and beat the suspected count of the dealer's hand. If the player's count exceeds 21, the player “busts.” If the player's hand is less than 17 he must take additional cards until his count is at least 17. The player may “stand” on any count of 17 through 21. If a player busts, the wager is lost unless the dealer also busts in which case player ‘pushes” with the dealer. After all of the players have taken hits or have stood on their hand, the dealer “stands” or “hits” based on pre-established rules for the game. If the dealer has less than 17, the dealer must take a hit. If the dealer has 17 or more, the dealer may stand 314.

Whichever of the dealer's hand or the player's hand is closest to a total of 21 without going over is the winner 316. All winning hand wagers are paid at odds of one-to-one 318. Each player's hand is then evaluated for the results of the jackpot wager 320. A jackpot award may consist of specific hands such as a suited player blackjack and a suited dealer blackjack. Each winning jackpot bet is paid according to the predetermined pay schedule for the jackpot wager 322. This concludes that round and players have the opportunity to play another round of the Twenty-One game 300.

An example of the instant invention wherein the game of Pai Gow poker has a zero house advantage, the dealer's strategy is fixed and the rules of bet resolution are symmetrical. That is the when the player wins both the high hand and low hand then he wins the bet. In a similar manner when the dealer wins both the high and the low hand he wins the bet. Thus the game can be set so the house advantage is zero by adjusting the combination of hands that will be “push” hands. It is preferred that the commission is eliminated and the resolution of the payment of tie hands between the player and the house becomes a push and thus the overall house edge becomes zero. All other outcomes are resolved as a push. The game is then theoretically has a zero house advantage with optimal player play. The house advantage lies in the adjustment of the percentage of the required jackpot wager.

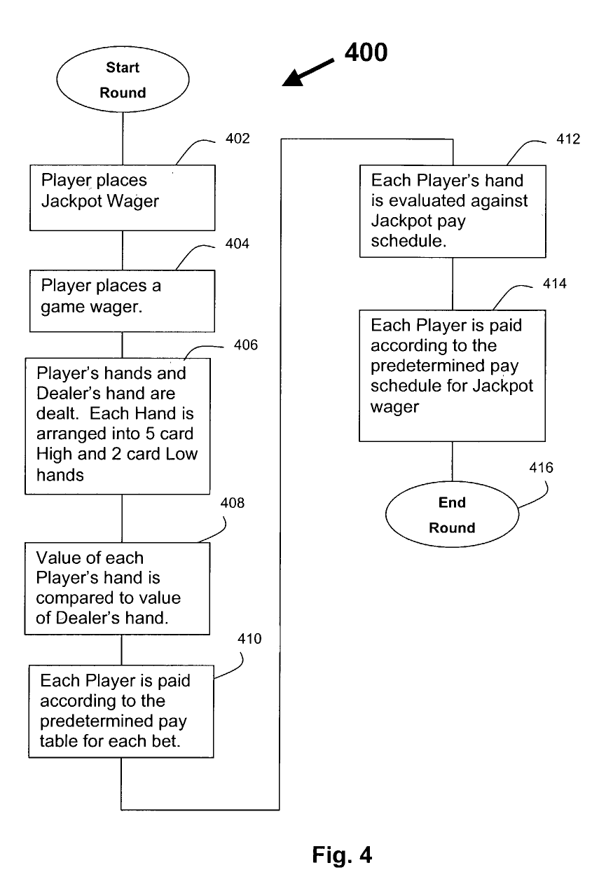

In operation, and referring to FIG. 4, the game begins with each player placing a jackpot wager 402. Each player then makes a game wager 404. The dealer then deals seven cards to each player and seven cards representing a dealer's hand 406. Each player arranges his or her seven cards into a five card high hand and a two card low hand. The five card high hand must outrank, according to the standard rankings of poker, the two card low hand. Once the players have arranged and exposed their high and low hands, the dealer exposes dealer's hand and likewise arranges them into a five card high hand and a two card low hand according to the same rules of the player. Thereafter the hands are resolved to determine wins, losses and pushes 408.

For a player to win the wager, both of the player's high and low hands must outrank, according to the standard rules of ranking hands of poker, the corresponding high and low hands of the dealer 410. If the player's hands do outrank the dealer's, the player wins the wager and is paid even money by the dealer. If the dealer's high and low hands outrank the player's corresponding high and low hands, that outcome is a loss for the player and the wager is collected.

If the player's high hand outranks the dealer's high hand but the dealer's high hand outranks the player's low hand, that is considered a push and the player's wager is neither won nor lost. Similarly, if the dealer's high hand outranks the player's high hand but the player's low hand outranks the dealer's low hand that also is considered a push. In resolving the hands, wherein any player's hand ties a dealer's hand, the dealer's hand is also a push. Each player's hand is then evaluated for the results of the jackpot wager 412. Each player is paid according to the predetermined pay schedule for the progressive wager 414. This concludes the round and Players have the opportunity to pay,another round of the game 416.

A fifth example is a method for playing a version of the casino table game of Roulette. The game of Roulette is a well-established game of chance played in casinos worldwide. The roulette wheel itself comprises a horizontal wheel having numbered pockets disposed radial around its periphery mounted at the bottom of a bowl-shaped housing adapted to rotate about its vertical axis. The number for each pocket is typically displayed adjacent to that pocket, and each number has an associated color, e.g., red or black, typically indicated by the color as the background whereon each number is marked. A conventional American roulette wheel has thirty-eight numbered pockets displaying the numbers 1 through 36 (each assigned a color of red or black), and the house numbers 0 and 00 (typically assigned the color green).

In playing the standard game players bet on the outcome of a number selection made by operation of the roulette wheel as described. The bets are made on a layout located on the gaming table adjacent to the wheel, which displays the numbers of the pockets on the roulette wheel and their characteristics, i.e., parity (odd or even) and color (red or black). Players signify their bets by placing chips or markers at predetermined locations on the betting layout on the possible number(s), odd or even red or black, or 00 or 0 hoping for selection by the operation of the roulette wheel.

In a zero house advantage game the odds for pay off of the wagers are made symmetrical for the probability of their occurrence. The house advantage provided by the addition of the “zero” and “double-zero” positions on the wheel are eliminated. They are replaced with a “push’ for the occurrence of these values as winning locations for any wager not made for that outcome. The game has then theoretically a zero house advantage. The house edge lies in the adjustment of the percentage of the required jackpot wager.

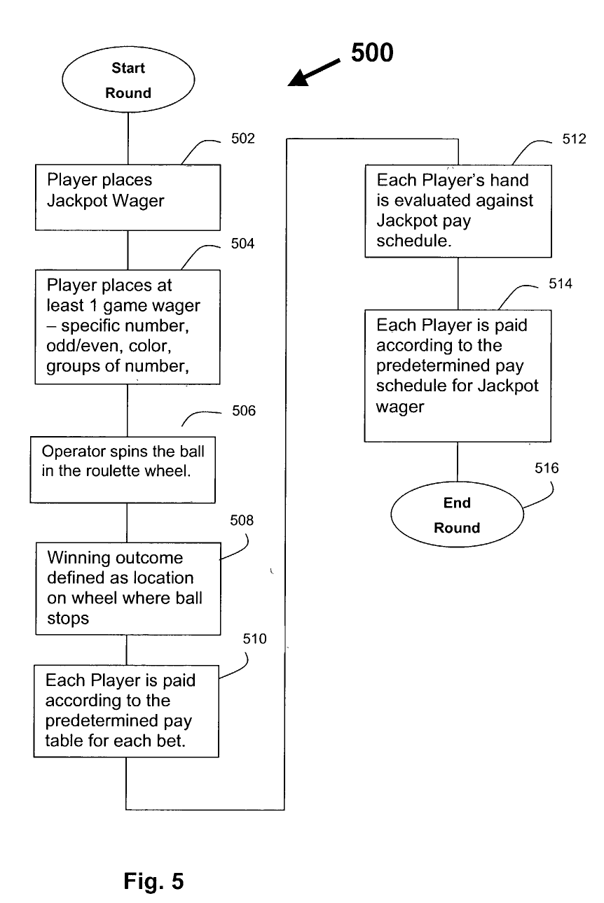

In operation, and referring to FIG. 5, the game begins with each player placing a mandatory jackpot wager 502. Each player then makes one or more game wagers 504. Bets may be made on individual numbers, by placing chips or markers thereon, or on combinations of adjacent numbers, by placing chips or markers on dividing lines between the numbered cells. Certain locations on the betting layout are defined for bets on certain combinations of numbers, or on red or black, or on odd or even.

Once the bets have been placed the operator or croupier introduces a small ball into the bowl surrounding the spinning wheel and projects the ball tangentially within the bowl, generally in a direction opposite to the rotation of the wheel 506. The ball may roll around the interior of the bowl several times before it loses speed and falls toward the center of the bowl, whereat it encounters the spinning roulette wheel. The ball bounces and eventually the ball becomes trapped in one of the numbered pockets of the wheel, thereby defining the outcome of the play 508.

Bets are paid on the winning outcome i.e., numbers, combinations of numbers or characteristics of the numbers, according to the conventional odds associated with the game of roulette 510. The payoff odds for a bet on a winning outcome are determined by the probability of the occurrence of a particular outcome. For example, a bet on an individual number pays 35 to 1, a bet on the combination of numbers 1-18 pays 2 to 1, and a bet on odd or even or red or black pays even money. All bets are a push if either a zero or double zero is the result, unless the bet is on the winning spin of zero or double zero. Each player's wager is then evaluated for the results of the jackpot wager 512. Each winning jackpot bet is paid according to the predetermined pay schedule for the jackpot wager 514. This concludes the round and players have the opportunity to play another round of the game 516.

Various modifications and additions may be made to these and other table games and will be apparent to those skilled in the art. Accordingly, the invention should not be limited by the foregoing descriptions, but rather should be defined only by the following claims. While the preceding examples illustrating several methods of assuring a zero house advantage in the play of underlying live table games with mandatory betting on jackpot games, the skilled artisans will understand how changes can be made without departing from the claims that follow.

What is claimed:

1. A method of including a jackpot as a required feature in an underlying live casino game in which each player makes at least one mandatory jackpot wager to play the live casino game and in which underlying live casino game a player makes a separate wager to win a separate, additional payoff amount, comprising the steps of:
(a) requiring each player to make at least one mandatory jackpot wager as an ante wager before participating in the underlying live casino game;
(b) separating the ante wager into at least a casino portion and a jackpot funding portion into a jackpot fund;
(c) requiring each player to make a wager on the underlying live casino game;
(d) including the jackpot feature on a pay schedule;
(e) displaying a particular winning arrangement on the pay schedule for the jackpot fund;
(f) playing the underlying live casino game in accord with its rules of play;
(g) displaying a pay table for the underlying live casino game with the payoffs for each of a pluralities of winning arrangements in accord with the rules of play for the underlying live casino game;
(h) setting the pay table to return of wagers for optimal play over time as payoffs to players on the basis of a zero or near zero negative house advantage;
(i) determining a payoff amount of each player achieving one of the plurality of winning arrangements of in accord pay table and the rules of the underlying live casino game, and
(j) paying to each player achieving the winning arrangement of the payoff amount according to the pay table and paying the total of the jackpot fund according to the pay schedule.

2. A method of claim 1 with the steps of:
(a) dealing a hand of playing cards from a standard deck of fifty two cards or a part thereof in performing step (f);
(b) displaying with the pay table payoffs for each of a pluralities of winning arrangements of cards in accord with the rules of play for the underlying live casino card game;
(c) selecting the pay table for the underlying live casino card games selected from the group of poker, blackjack, Pai Gow poker;
(d) arranging the pay table and the rules for the underlying live casino card game to return over time the table take as payoffs to each of the players on the basis of the optimal play with the zero or near zero negative house advantage for each;
(e) determining a payoff amount of each player achieving one of the plurality of winning arrangements of cards of in accord pay table and the rules of live casino card game, and
(f) paying to each player achieving any of the winning arrangements of cards the payoff amount according to the pay table and paying the total of the jackpot fund according to the pay schedule.

3. A method of claim 1 with the steps of:
(a) projecting a roulette ball on a rotating roulette bowl in performing step (f);
(b) displaying with the pay table payoffs for each of a pluralities of winning ball stop positions in accord with the rules of play for the underlying live casino roulette game;
(c) arranging the pay table and the rules for the underlying live casino roulette game to return over time the table take as payoffs to each of the players on the basis of the optimal play with the zero or near zero negative house advantage for each;
(d) determining a payoff amount of each player achieving one of the plurality of winning arrangements of roulette ball stop positions in accord the pay table and the rules of live casino roulette game, and
(e) paying to each player achieving any of the winning ball stop position the payoff amount according to the pay table and paying the total of the jackpot fund according to the pay schedule.

4. The method of claim 1 with the step of separating the ante wager into at least a casino portion and a jackpot funding portion into a jackpot fund with the added step of growing the jackpot funding portion progressively to achieve a progressive jackpot fund.

5. The method claim 4 with the steps of displaying on a meter the current progressive jackpot fund amount as incremented to the total of each progressive jackpot funding portion anted and paying to each player achieving the winning arrangement the payoff amount according to the pay table and paying the total of the jackpot funding incremented on the meter as the total of the jackpot fund.

6. The method of claim 1 with the step of paying from the jackpot funding portion by the step of holding in a community jackpot from which all the players in the game share in the winnings if one player and the dealer or two players tie for the jackpot.

7. A method of playing concurrently a underlying live casino game and a jackpot game, the method comprising the steps of:
a. providing jackpot game requiring at least one wager to support the house and the jackpot;
b. providing an underlying live casino game requiring at least another wager;
c. playing optimally the underlying live casino game under rules which are symmetrical as between each player and dealer wherein the paying out of winnings to the players and collecting of losses from the players by the house have a house advantage that is zero or approaches zero;
d. paying out in accord with the results of the playing of the underlying live casino game in line with the rules;
f. determining if there was a jackpot win, and
g. paying the winner of the jackpot.

8. A method of including a jackpot as a required feature in an underlying video representation of a live casino game in which each player makes at least one mandatory jackpot wager to play the video representation of a live casino game and in which underlying video representation of a live casino game a player makes a separate wager to win a separate, additional payoff amount, comprising the steps of:
a. requiring each player to make at least one mandatory jackpot wager as an ante wager before participating in the underlying live casino game;
b. separating the ante wager into at least a casino portion and a jackpot funding portion into a jackpot fund;
c. requiring each player to make a wager on the underlying video representation of a live casino game;
d. including the jackpot feature on a pay schedule;
e. displaying a particular winning arrangement on the pay schedule for the jackpot fund;
f. playing the underlying video representation of a live casino game in accord with its rules of play;
g. displaying a pay table for the underlying video representation of a live casino game with the payoffs for each of a pluralities of winning arrangements in accord with the rules of play for the underlying live casino game;
h. setting the pay table to return of wagers for optimal play over time as payoffs to players on the basis of a zero or near zero negative house advantage;
i. determining a payoff amount of each player achieving one of the plurality of winning arrangements of in accord pay table and the rules of the underlying video representation of a live casino game, and
j. paying to each player achieving the winning arrangement of the payoff amount according to the pay table and paying the total of the jackpot fund according to the pay schedule.
